(19) United States
(12) Patent Application Publication
(10) Pub. No.: US 2026/0166841 A1
(43) Pub. Date: Jun. 18, 2026

(54) TUFTED CARPET AND BACKING THEREFORE

(71) Applicant: Carl Freudenberg KG, Weinheim (DE)

(72) Inventors: Alexandra KAUL, Hemsbach (DE); Ulrike HERRLICH, Bammental (DE)

(21) Appl. No.: 18/979,753

(22) Filed: Dec. 13, 2024

(51) Int. Cl. B32B 5/26; A47G 27/02; B32B 5/02; B32B 5/06; B32B 37/06; B32B 37/18; B32B 38/00

(52) U.S. Cl. CPC B32B 5/266; A47G 27/02; B32B 5/022; B32B 5/073; B32B 37/06; B32B 37/18; B32B 2038/008; B32B 2255/02; B32B 2262/0284; B32B 2262/067; B32B 2305/18; B32B 2309/02; B32B 2471/02

(57) ABSTRACT

A tufted carpet including a primary backing which includes (i) a first nonwoven which includes fibers including polyethylene terephthalate (PET), and (ii) a second nonwoven which includes non-melting fibers and is mechanically bonded. Tufts of yarn which are sewn through the primary backing such that piles of yarn are on a surface of the first nonwoven and backloops of yarn are on a surface of the second nonwoven. The backloops of yarn are thermobonded to the primary backing.

### FIELD

The present invention relates to tufted carpets.

### BACKGROUND

Typically, tufted carpets are produced by stitching a plurality of rows of yarn loops through a previously-manufactured backing so that the yarn protrudes on one surface of the backing as a pile, and is drawn relatively closely against the opposite surface of the backing. The pile of yarn loops may be permitted to remain as loops, or may be sheared or otherwise cut to create a cut pile rather than a looped pile. In order to prevent damage during use, the tufted yarns are bonded to the backing after tufting. The tufted yarn is usually bonded to the backing by applying an adhesive on the bottom side of the backing, in such a manner as to adhere the back loops of the yarn to the backing.

A common application for tufted carpets in the art is interior automotive parts. For automotive applications, tufted carpets can be formed into shaped parts by molding. Tufted carpets which are used as substrates for molding should have specific properties. For molding, the tufted carpets should be light-weight, such that it can be formed and bent conveniently. It must comprise a sufficient amount of thermoplastic polymer, which renders it susceptible to forming and shaping. The shaped parts should have mechanical stability for long-term use. The tufted carpets and shaped parts should also be available in a simple and effective process.

WO 2004/071758 A1 relates to an automotive tufted carpet with improved acoustic properties which is formed from a two-layer primary backing. The first layer is a woven or nonwoven or spunbond material, and the second layer is a microfilament spunlaced material. The tufts of yarn are sewn through the primary backing and bonded with an adhesive web. The tufted carpet may comprise a polyester nonwoven, a nonwoven from polyethylene/polyamide bicomponent fibers, a polypropylene adhesive web and tufts of yarn from polyamide. The automotive tufted carpet can be molded into shaped parts. However, an adhesive layer for bonding increases the complexity of the preparation process and product, but also the weight of the tufted carpet.

In the art, methods for preparing tufted carpets have been developed, in which the tufts of yarn are thermobonded. Thermobonding is a process in which a thermoplastic substrate, in the present case the yarn, is softened or molten and bonded, without the need for an additional adhesive or adhesive layer. A thermobonding process can be advantageous, because no additional adhesive is required. Thus, the product and process are simpler, and undesirable side effects of adhesives, such as thermal instability or odor, can be avoided.

The primary backing of WO 2004/071758 A1 are based on polyamides and polyolefins, which have a relatively low melting point. Therefore, tufted carpets from such primary backings and tuft yarns of higher melting point, such as PET yarns, cannot be thermobonded. This is not possible, because the polymers which have a lower melting temperature than the yarn would melt during thermobonding, and the primary backing would be disintegrated.

U.S. Pat. No. 4,705,706 discloses a method for preparing tufted carpets, in which the back-loops of the stitches of pile yarn are fastened to the backing by thermal bonding, obviating the need for applying an adhesive coating to the underside of the backing. The thermal bonding is accomplished by using as the pile yarn from thermoplastic material which becomes tacky at a temperature below that at which the backing is softened or molten. In the example, a polyethylene yarn is thermally bonded to a nylon backing.

EP 1,598,476 A1 relates to a device and method for preparing tufted carpets, in which thermoplastic tufts of yarn are thermobonded to a backing when passing a heated surface of a roll. For improving the stability, an additional thermoplastic adhesive can be applied to the underside of the backing before thermobonding.

When thermobonding the tufts of yarn in such methods, the use of an adhesive can be avoided or at least reduced. Thus, the tufted carpet does not require a latex, hot melt adhesive or the like. However, it is a problem of such methods that the yarn must have a softening temperature which is significantly below the softening temperature of the fibers and structural components of the primary backing. Otherwise, the primary backing would also be molten and disintegrated when the heat in the thermobonding step is applied. Therefore, such thermobonding methods are only suitable for certain types of tufted carpets, wherein the yarns have a significantly lower melting temperature than the primary backing, such as polyolefin or polyamide yarns on a PET backing. In contrast, if yarns from high melting temperature polymers, such as PET, are thermobonded on primary backings, which comprise fiber materials and polymers of the same or lower melting temperature, such as PET, polyamide or polyolefin, such polymers of the same and lower melting point can melt and the structure and integrity of the primary backing can be damaged or destroyed.

### SUMMARY

In an embodiment, the present disclosure provides a tufted carpet comprising a primary backing which includes (i) a first nonwoven which comprises fibers comprising polyethylene terephthalate (PET), and (ii) a second nonwoven which comprises non-melting fibers and is mechanically bonded. Tufts of yarn which are sewn through the primary backing such that piles of yarn are on a surface of the first nonwoven and backloops of yarn are on a surface of the second nonwoven. The backloops of yarn are thermobonded to the primary backing.

### BRIEF DESCRIPTION OF THE DRAWINGS

Subject matter of the present disclosure will be described in even greater detail below based on the exemplary FIGURES. All features described and/or illustrated herein can be used alone or combined in different combinations. The features and advantages of various embodiments will become apparent by reading the following detailed description with reference to the attached drawings, which illustrate the following:

FIG. 1 shows mechanical properties of test samples of tufted carpets according to the present disclosure.

### DETAILED DESCRIPTION

It would be desirable to provide tufted carpets and methods for their production, which overcome the above-mentioned drawbacks.

Embodiments of the present invention provide tufted carpets, shaped parts, and methods for their production, which overcome the above-mentioned drawbacks. The tufted carpet should especially be suitable for preparing shaped parts by molding, for example for automotive interior applications. The tufted carpets and shaped parts should have high mechanical and thermal stability and be relatively lightweight. Preferably, the production method should be convenient, relatively simple, and efficient. The use of an adhesive should be avoided.

Tufted carpets and methods, which can be used for a wide range of materials, are also provided. Specifically, products which can be prepared at relatively high temperature are provided. For example, the provided production methods allow the manufacturing of a wide range of tufted carpets based on PET components.

A thermobonding method is provided for tufted carpets with PET yarn. PET has high mechanical and thermal stability and is generally suitable for industrial applications at large scale. However, since PET has a relatively high melting temperature of >250° C., thermobonding PET yarns without damaging primary backings from lower melting filaments or PET is difficult.

In an embodiment, the present invention provides a tufted carpet comprising a primary backing which includes:
(i) a first nonwoven which comprises fibers comprising polyethylene terephthalate (PET), and
(ii) a second nonwoven which comprises non-melting fibers and is mechanically bonded; and
tufts of yarn which are sewn through the primary backing such that the piles of yarn are on the surface of the first nonwoven and the backloops of yarn are on the surface of the second nonwoven, wherein the backloops of yarn are thermobonded to the primary backing.

The tufted carpet comprises tufts of yarn and a primary backing. The piles of yarn, which can be cut open or closed, are on the surface of the first nonwoven (also referred to as the upper side or front side, which is exposed to the environment in standard applications). The thermobonded backloops of yarn are on the surface of the second nonwoven (also referred to as the lower side or bottom side). The backloops of yarn are thermobonded to the primary backing. In the thermobonding process, heat and pressure are applied to the primary backing on the side of the second nonwoven having the backloops of yarn at the surface. The heat softens or melts the backloops, and the yarn becomes attached to the primary backing when being solidified. The backloops of yarn can also thermobonded to each other, at least partially, which can further increase the stability of the tufted carpet. Thermobonding can be carried out by passing the tufted carpet over a heated role, for example with a device as described in EP 1 598 476 A1. A tufted carpet is obtained, in which the yarn is tightly attached to the primary backing.

When the tufted carpet of the present disclosure is consolidated by thermobonding, the second nonwoven can shield the first nonwoven from heat. Surprisingly, it was found that the thermobonding process can be carried out at a temperature, at which the first nonwoven would normally be molten and damaged. The second nonwoven from non-melting fibers can protect the first nonwoven from melting and damages, even when a thermobonding temperature above the melting point of the first nonwoven fibers is applied.

As used herein, the term “yarn” refers to any textile fiber or fiber assembly, which is suitable for tufting the primary backing. The yarn is of long continuous length of interlocked fibers or from a single strand of polymer material. Typically, for obtaining a uniform product, a single type of yarn is used. In principle, the tufted carpet can comprise any conventional thermoplastic tufting yarn. For example, the yarn material can be polyester, polyamide or polyolefin, such as polypropylene. However, further advantages of the present disclosure can be achieved when using tufting yarn having a relatively high melting temperature.

It is preferred that the tufted carpet of the present disclosure has high temperature stability. Thus, also the yarn has preferably a relatively high melting temperature. In a preferred embodiment, the yarn has a melting temperature of at least 240° C., preferably at least 250° C., for example in the range of 240° C. to 265° C. In a preferred embodiment, the yarns are polyester yarns, especially from polyethylene terephthalate (PET). PET yarns are preferred, because they can provide high mechanical and thermal strength to tufted carpets, and are easily available at relatively low costs. In a preferred embodiment, the PET has a melting point of >250° C. In another embodiment, the PET is recycled (r-PET). Recycled PET typically has a melting point between 240° C. and 250° C.

The primary backing comprises a first nonwoven and a second nonwoven. A nonwoven is an engineered assembly of fibers, primarily planar, which has been given a designed level of structural integrity by physical and/or chemical means; excluding weaving, knitting or paper making. As used herein, the term fibers includes staple fibers and filaments. Staple fibers are fibers of defined or limited length and filaments are continuous fibers, also referred to as endless fibers.

The primary backing comprises a second nonwoven which comprises non-melting fibers. Surprisingly, it was found that the primary backing with a second nonwoven from non-melting fibers enables thermobonding of tuft yarns having high melting temperature, such as PET yarns. The melting point of PET is >250° C. In the art, efficient and convenient thermobonding methods for preparing tufted carpet with PET yarns on PET backings were not available.

Non-melting fibers are fibers which do not melt before pyrolysis. They are also referred to as char-forming fibers. Such non-melting fibers are pyrolyzed upon heating and preserve their basic fibrous structure. Typically, the melting temperature T_{M} (if available) is equal or larger than the pyrolysis temperature T_{P}. Preferably, the pyrolysis temperature of the non-melting fibers is at least 250° C., more preferably at least 300° C. The T_{M} and/or T_{P} can be determined according to ASTM D276-00a of 2008.

In a preferred embodiment, the non-melting fibers are organic fibers, typically synthetic fibers, semi-synthetic fibers or natural fibers. Inorganic fibers are not preferred, because they do not have sufficient elasticity for efficient tufting. Preferably, the non-melting fibers are regenerated cellulose fibers, especially viscose (rayon) fibers, aramide, polyacrylonitrile (PAN) or partially oxidized polyacrylonitrile (OPAN) fibers, natural fibers or mixtures thereof. Preferably, the natural fibers are cotton, cellulose, wood pulp, bamboo or wool fibers.

It is especially preferred that the non-melting fibers are regenerated cellulose fibers (RCF), preferably viscose fibers. Regenerated cellulose fibers are semi-synthetic fibers based on cellulose. The regenerated cellulose fibers can be viscose (rayon) or lyocell fibers (Tencel-fibers). Regenerated cellulose fibers are non-melting and have relatively high thermal stability. Typically, the pyrolysis temperature is about 350° C. RCF can be prepared by conventional processes, such as the viscose or lyocell process. It was found that regenerated cellulose fibers, such as viscose fibers, can confer advantageous properties to the tufted carpet and production process. A second nonwoven comprising viscose fibers can effectively shield the first nonwoven from melting and damages by the heat applied during thermobonding. Regenerated cellulose, and especially viscose, has physical properties which are compatible with PET and thus the primary backings can be processed and tufted conveniently and can have high stability.

In a preferred embodiment, the second nonwoven consists of non-melting fibers. This can be advantageous, because the shielding effect on the first nonwoven is especially high. Nonetheless, a second nonwoven from 100% non-melting fibers is suitable for providing the tufted carpet and shaped part having advantageous mechanical properties.

In a preferred embodiment, the second nonwoven comprises 10 to 100 wt. % of the non-melting fibers and 0 to 90 wt. % melting fibers. Preferably, the non-melting fibers are regenerated cellulose fibers and the melting fibers are PET fibers. It was found that a second nonwoven, which comprises melting fibers, can effectively shield the first nonwoven from the heat applied during thermobonding. Preferably, the amount of non-melting fibers is between 10 and 80 wt. %, preferably between 20 and 60 wt. %. Thus, the overall tufted carpet can be highly uniform, if the first nonwoven and/or yarn are also from PET, which can be advantageous for stability, manufacturing and recycling.

In a preferred embodiment, the second nonwoven is mechanically consolidated, for example spunlaced (hydroentangled) or needle-punched. Preferably, the second nonwoven is spunlaced. This is a process for consolidating and bonding wet or dry fibrous webs, in which high pressure jets of water or air are directed onto the web. The jets penetrate the web and entangle the fibers, such that dense and uniform structure is provided. A spunlaced second nonwoven is advantageous, because no adhesive is required for bonding and the second nonwoven can have high mechanical stability.

The primary backing includes a first nonwoven which comprises fibers comprising polyethylene terephthalate (PET). The first nonwoven confers stability to the tuft yarns and the overall tufted carpet. The PET fibers can provide high mechanical and thermal stability to the primary backing.

Preferably, the first nonwoven is spunbonded (is a spunbond nonwoven). Spunbonded PET nonwovens with a thermobonded binder component are commercially available, can have high stability and are highly uniform. Spunbonded nonwovens consist of continuous fibers (filaments).

The first nonwoven comprises fibers which are formed from PET as a fiber forming material. The fibers can be monocomponent PET fibers or multicomponent fibers comprising a PET component. The first nonwoven can consist of the fibers comprising PET or a fiber mixture comprising the fibers comprising PET. Preferably, the fiber mixture comprises at least 50 wt. %, more preferably at least 80 or at least 90 wt. % PET fibers. For a uniform product, it is preferred that the first nonwoven consists of polyester fibers.

Preferably, the first nonwoven is thermobonded. This means that the first nonwoven has been consolidated by thermobonding before being used for the primary backing. For thermobonding, the first nonwoven comprises a lower-melting fiber forming polymer material for bonding the PET fibers or PET component together upon heating, i.e. when the lower-melting polymer material is softened or molten. Thus, the term “lower-melting” means that the polymer materials has a lower melting point than the PET. Preferably, the thermobonded first nonwoven has been bonded by fibers from the lower melting polymer material, or by multicomponent fibers comprising a PET component and a fiber component from the lower melting polymer material.

The lower-melting polymer material has a lower melting point than PET, preferably of less than 230° C. For example, the melting temperature T_{M} of the lower melting polymer, especially CoPET, is between 180° C. and 240° C., preferably between 185° C. and 230° C.

The lower melting polymer material can be a conventional fiber material, such as copolyester, polyamide, polyethylene or polypropylene. It is especially preferred that the lower melting polymer material is copolyester, most preferably co-polyethylene-terephthalate (CoPET). The copolyester can also be based on another polyester. For example, the polyester can be co-polybutylene-terephthalate (CoPBT).

Such a combination can be advantageous, because PET and copolyester, especially CoPET can have similar structure and properties, which can increase the stability and facilitate processing and recycling.

In a preferred embodiment, the first nonwoven comprises a mixture of PET fibers and fibers from the lower melting polymer material, preferably a mixture of PET fibers and CoPET fibers. In another preferred embodiment, the first nonwoven comprises multicomponent fibers, typically bicomponent fibers, from a PET component and a component from the lower melting polymer material. Especially preferred are bicomponent fibers of the PET/copolyester (CoPET), PET/polyamide, PET/polyethylene or PET/polypropylene type. Preferably, the bicomponent fibers are of the sheath/core type or side/side type, having the low-melting component for bonding exposed to the surface. Such nonwovens are thermobonded via the low-melting fibers or component, before the first nonwoven is included into the primary backing.

It is especially preferred that the first nonwoven comprises or consists of PET/CoPET bicomponent sheath/core fibers. Such a first nonwoven can confer high stability and high temperature stability to the primary backing for the tufted carpet. It is also highly compatible with tufts of PET yarn, thereby providing a relatively uniform polyester based primary backing.

Preferably, the amount of binder fibers in the first nonwoven, or binder component in the bicomponent fibers, is about 1 to 30 wt. %, preferably 5 to 25 wt. %, wherein the rest is the PET fibers or PET component.

In a highly preferred embodiment, the overall primary backing comprises only polyester fibers and non-melting fibers and the yarn is PET yarn. It is especially preferred that all fibers in the first nonwoven are monocomponent PET fibers and monocomponent CoPET fibers and/or PET/CoPET bicomponent fibers. It is highly preferred that the non-melting fibers are regenerated cellulose fibers, because they are highly compatible with PET and polyester fibers. Such a polyester based tufted carpet with additional regenerated cellulose fibers is especially advantageous, because it can be thermobonded and molded conveniently at relatively high temperature without adversely affecting the first nonwoven. The uniform structure can also be advantageous for recycling. Such a tufted carpet has excellent properties for automotive tufted carpets.

In a preferred embodiment, the tufted carpet does not comprise an adhesive. This means that the connection between the primary backing layers and tufted yarn has been established without adhesive. Thus, it is not necessary to include an additional adhesive layer, or to adhesively bond the tufts of yarn to the primary backing. Preferably, the tufted carpet is only bonded by sewing the tufts of yarn through the primary backing and thermobonding the tufted yarns. In this regard, it is preferred that at least some of the molten or softened yarn polymer also bonds the first and second nonwoven to each other. Thereby, a relatively simple, adhesive-free structure can be obtained, which can have high thermal and mechanical stability. Avoiding adhesives is generally advantageous in convenience applications, because adhesives can have a relatively low melting point and can become brittle and unstable, for example upon long-term exposure to heat, moisture or sunshine.

In another embodiment, an adhesive is used for preparing the tufted carpet. For example, an adhesive bonding layer can be used for bonding the first and second nonwoven together, or adhesive can be added onto the second nonwoven surface before thermobonding. However, such an additional adhesive may not be required, because high stability can be achieved without adhesive.

In a preferred embodiment, the primary backing and/or tufted carpet does not comprise a polyolefin and/or polyamide. This can be advantageous for a homogeneous product based on polyester and for processing, especially thermobonding the yarns, because polyolefin and polyamide have relatively low melting temperatures.

In a preferred embodiment, the second nonwoven has a base weight between 20 to 80 g/m², especially between 30 to 60 g/m². Such base weight is relatively low for a primary backing component, which is typically used for conferring mechanical stability to the tufted yarn and carpet. Surprisingly, the shielding effect of the second nonwoven during thermobonding can be achieved even when the second nonwoven has a relatively low weight. A thin second nonwoven is also advantageous for thermobonding, because molten yarn polymer from backloops can penetrate the second nonwoven and contact the first nonwoven, thereby creating bonds between the yarn, first and second nonwoven, which increases the overall stability of the tufted carpet.

Preferably, the base weight of the first nonwoven is higher than the base weight of the second nonwoven. In a preferred embodiment, the first nonwoven has a base weight between 50 to 150 g/m², more preferably 80 to 120 g/m². The first nonwoven can provide mechanical stability, especially to the tufted carpet, whereas the second nonwoven can shield the first nonwoven from heat during thermobonding. Typically, the tufted carpet has a base weight between 400 to 1500 g/m². Overall, the tufted carpet can have a relatively low base weight and can be molded and shaped conveniently.

Preferably, the average diameter of the fibers of the first and second nonwoven is between 3 to 15 dtex, more preferably 5 to 12 dtex. It was found that a tufted carpet for automotive applications and molding can be prepared from fibers having such dimensions.

In a preferred embodiment, the primary backing consists of the first and second nonwoven. This is advantageous, because the product is simple but highly stable. However, if desired further layers can be included into the primary backing. In this regard, the second nonwoven should always form the outer surface, with the backloops of yarn which are thermobonded. The first nonwoven, which is shielded from heat during thermobonding, can be combined with other layers, such as further nonwovens. For example, a third, fourth or further layer(s), preferably nonwoven layer(s), can be included on the upper side of the first nonwoven and/or between the first and second nonwoven, if desired.

Preferably, the tufted carpet comprises a primary backing which consists of
(i) a thermobonded first nonwoven from bicomponent PET/CoPET fibers or a mixture of PET fibers and CoPET fibers, and
(ii) a spunlaced second nonwoven from regenerated cellulose fibers and optionally PET fibers; and
tufts of PET yarn which are sewn through the primary backing such that the piles of yarn are on the surface of the first nonwoven and the backloops of yarn are on the surface of the second nonwoven, wherein the backloops of yarn are thermobonded to the primary backing.

In a preferred embodiment, the tufted carpet comprises a back coating on the surface of the second nonwoven. In a preferred embodiment, a secondary backing is adhered to the back coating. Preferably, the back coating and/or secondary coating are from SBR, natural latex, polyethylene, ethylene vinyl acetate or mixtures thereof. Such back coatings are used in the art for covering the thermobonded backloops of yarn and/or for conferring desired properties to the tufted carpet.

A method is also provided for preparing the tufted carpet as defined above, the method comprising the steps of:
providing a stack comprising:
(i) a first nonwoven, which comprises PET fibers, and
(ii) a second nonwoven, which comprises non-melting fibers, and is mechanically bonded,
sewing tufts of yarn through the stack, such that the piles of yarn are on the surface of the first nonwoven and the backloops of yarn are on the surface of the second nonwoven, and
thermobonding the backloops of yarn.

Steps (a) to (c) are carried out in consecutive order. The first and second nonwoven are laid flat over each other. The method for preparing tufted carpet from a loose stack of primary backing is also known as thermopile bonding process. Alternatively, the first and second nonwoven layers can be pre-bonded to each other. In step (b), the tufts of yarn are sewn through the stack in a conventional manner, typically with needles in a tufting device. The sewn tufts of yarn join the first and second nonwoven to each other. Depending on the intended use, the piles of yarn on the front side can be opened or can remain closed loops.

In thermobonding, the bottom side of the tufted carpet is contacted with a hot surface, preferably a hot roll. Methods and devices for thermobonding tufted carpets are commercially available and known in the art, for example from EP 1 598 476 A1. Typically, the contact time with the hot surface is short, such that the carpet is briefly heated on the bottom side, whilst heat transfer to the other side is restricted. Typically, the time of contact is less than one minute, for example between 1 to 30 seconds. In a preferred embodiment, the thermobonding in step (c) is carried out at a temperature of at least 250° C., preferably at least 260° C., or even about 262 to 263° C. The thermobonding temperature can be adjusted such that the primary backing is not damaged. Such high temperatures are especially suitable for effectively bonding tufted carpets with PET yarns.

In a preferred embodiment, no adhesive bonding is carried out during or between steps (a) to (c). Especially, no latex binder or hot melt adhesive is added. This is advantageous, because the process and structure of the product can be relatively simple.

A shaped part is also provided, which comprises at molded tufted carpet as defined above. A method for preparing the shaped part is provided, the method comprising the steps of
providing a tufted carpet as defined above, and
molding the tufted carpet.

The term “shaped part” refers to an object having a defined three dimensional structure, which is conferred purposefully to it. Typically, the shaped part can maintain its structure in the absence of an external force. The tufted carpet can be provided in step (A) in a size and form which corresponds to the dimensions of the shaped part. Typically, the tufted carped is cut to a piece of defined dimensions. Step (B) is carried out in a molding device under sufficient heat and pressure, thereby conferring the desired shape to the tufted carpet. When the molded part is allowed to cool, the thermoplastic components are consolidated and the shaped part is obtained. If desired, the form of the shaped part can be adapted subsequently, for example by (water jet) cutting. Typically, the shape of the part is adapted to the intended used, for example such that it fits into an automotive interior structure. The tufted carpet or shaped part can be provided for common applications, especially for the automotive industry, for example for vehicle floor systems, carpets, mats, ceiling parts, panels, covers or acoustic absorbers.

A primary backing is also provided for a tufted carpet, wherein the primary backing includes a first nonwoven which comprises PET fibers, and a second nonwoven which comprises non-melting fibers and is mechanically bonded. A use of a primary backing for preparing a tufted carpet in a thermobonding process is also provided. For the shaped part, primary backing and use, the features and embodiments can be selected as outlined above for the tufted carpet and method.

### EXAMPLES

Primary backings were prepared and the thermal stability was tested under conditions typical for thermobonding.

### Examples 1 to 5: Primary Backings

Primary backings were prepared as follows:

Example 1 (comparative): The primary backing is a spunbond nonwoven comprising 92% PET filaments and 8% CoPET filaments having a base weight of 100 g/m².

Example 2 (comparative): The primary backing is a spunlace 100% viscose nonwoven having a base weight of 30 g/m².

Example 3: The primary backing consists of a layer spunbond nonwoven comprising 92% PET filaments and 8% CoPET filaments having a base weight of 100 g/m² of example 1, and a layer of spunlace 100% viscose nonwoven having a base weight of 30 g/m² of example 2.

Example 4 (comparative): The primary backing is a spunlace nonwoven from 30% viscose fibers and 70% PET fibers having a base weight of 55 g/m².

Example 5: The primary backing consists of a layer of the spunbond nonwoven comprising 92% PET filaments and 8% CoPET filaments having a base weight of 100 g/m² of example 1 and a layer of the spunlace nonwoven from 30% viscose fibers and 70% PET fibers having a base weight of 55 g/m² of example 4.

Example 6 (comparative): The primary backing is a spunlace nonwoven from 50% viscose fibers and 50% PET fibers having a base weight of 45 g/m².

Example 7: The primary backing consists of a layer of the spunbond nonwoven comprising 92% PET filaments and 8% CoPET filaments having a base weight of 100 g/m² of example 1 and a layer of the spunlace nonwoven from 50% viscose fibers and 50% PET fibers having a base weight of 45 g/m² of example 6.

Example 8: Testing of thermal stability

A hot iron plate is heated to 262° C. surface temperature. The surface temperature is measured by a contact temperature sensor. A test sample was prepared by winding a stripe of the primary backing sample (3 cm×15 cm) around an iron weight (263 g, melting area 4 cm×3 cm) which is surrounded by a cotton fabric. In examples 3 and 5, the layer with viscose fibers was the bottom layer directed towards the iron plate, whereas the polyester layer was the upper layer. The test sample is laid for 5 seconds on the hot iron plate and removed. The damage of the primary backing sample is detected visually. The results are summarized in table 1 below.

TABLE 1
Results of examples 1 to 5

| Ex | Result |
|---|---|
| 1 (comp) | backing is totally molten |
| 2 (comp) | backing turns slightly yellow but stays intact |
| 3 | viscose nonwoven turns slightly yellow but stays intact |
| | PET/CoPET nonwoven stays intact, no melting of PET/ |
| | CoPET material detected |
| 4 (comp) | backing shrinks and turns slightly yellow but does not melt |
| 5 | viscose nonwoven turns slightly yellow and shrinks but |
| | stays intact PET/CoPET nonwoven stays intact, no melting |
| | of PET/CoPET material detected |

The results show that the lower viscose layer, which is in contact with the hot metal, can shield and protect the upper polyester nonwoven layer (example 3) from the heat applied to the bottom side. In contrast, without protective viscose layer, the PET/CoPET nonwoven layer is molten (comparative example 1). Thus, the viscose layer can effectively shield the PET layer, although the temperature of the hot metal of 262° C. is significantly higher than the melting temperature of PET which is >250° C., and the melting temperature of CoPET is even lower. Example 5 demonstrates that even a first nonwoven which comprises only 30% viscose can shield the polyester nonwoven effectively. The direct contact with the hot metal is an adequate simulation of a conventional thermobonding process in which the backing with the tufted yarn is led over a hot roll having the same temperature. The results demonstrate that the primary backing of the present disclosure is suitable for manufacturing tufted carpets in a thermobonding process at temperatures, at which the primary backing would normally be molten or damaged. Thus, the disclosed methods and primary backings allow the manufacturing of new thermobonded tufted carpets, which were not available by conventional thermobonding.

Examples 9 to 11: Preparation of tufted carpets

In the following examples 9 to 11, tufted carpets were prepared from primary backings of the above-mentioned examples 1, 3 and 7 by tufting PET yarn on a Penhill sample tufting machine under the following conditions into the primary backings: 1080D 120F BCF PET yarn, 56 stitches per 10 cm, 1/10″ gauge cut-pile, 5 mm pile height and 400 g/m². Subsequently the backstitch sides of the materials were treated on a heated roll with various temperature and time conditions for thermobonding the yarn backstitches into the primary backing. The bonding is designated as suitable (good) bonding when the fibers show a medium grade of adhesion to the backing.

Example 9 (comparative): Tufted carpets were prepared by tufting PET yarn into a single-layer primary backing of example 1 and subsequent treatment on a heated roll. The conditions and results are outlined in the following:

9a: 258° C., 20 seconds: good bonding, untufted edge is completely molten.

9b: 262° C., 6 seconds: insufficient bonding, untufted edge is completely molten.

Example 10: Tufted carpets were prepared by tufting PET yarn into a two-layer primary backing of example 3 and subsequent treatment on a heated roll. The conditions and results are outlined in the following:

10a: 258° C., 20 seconds: good bonding, untufted edge is not destroyed.

10b: 262° C., 6 seconds: insufficient bonding, untufted edge is not destroyed.

10c: 262° C., 15 seconds: good bonding, untufted edge is not destroyed.

Example 11: Tufted carpets were prepared by tufting PET yarn into a two-layer primary backing of example 7 and subsequent treatment on a heated roll. The conditions and results are outlined in the following:

11a: 258° C., 20 seconds: good bonding, untufted edge is not destroyed.

11b: 262° C., 6 seconds: insufficient bonding, untufted edge is not destroyed.

11c: 262° C., 15 seconds: good bonding, untufted edge is not destroyed.

Example 12: Preparation of compressed parts and examination of mechanical properties

For determining if the tufted carpets are suitable for molding, test samples were prepared and the mechanical properties were analyzed. Tufted carpets of above-mentioned examples 9 to 11 were coated with polyethylene and compressed under heat and pressure. In a Benz coating line, at a line speed of 0.275 m/min, the backstitch sides of the carpets were strayed with 300 g/m² polyethylene powder (trademark Schaetti Fix 140), heated by an IR field to 160° C., fed with a second nonwoven layer (30 g/m², polyester spunbond), pressed in a calender to 1.4 bar and then dried in the oven at 120° C. Round samples with a diameter of 24 cm were cut out and placed in a clamping device with the backstitch facing upwards. The samples were heated by an IR field to 180° C. and then pressed into a hollow, water-cooled brass sphere with a diameter of 10 cm and a temperature of 18° C. at a speed of 50 mm/seconds.

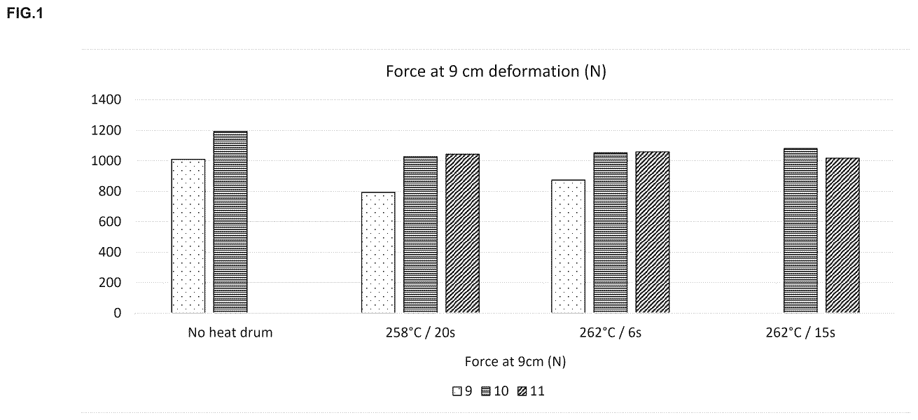

The mechanical properties of the test samples were examined. The maximum force (N) at breakage of the material, the deformation path (cm) at breakage of the material and the force (N) at 9 cm deformation path were detected. The force at a deformation at 9 cm is a good measure for moldability. The results are shown in FIG. 1. It was found that the force at 9 cm deformation is significantly higher for the samples of examples 10 and 11 than for the comparative samples of example 9. The results show that the tufted carpet according to the present disclosure can advantageously be used for preparing shaped parts by molding.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A tufted carpet comprising:
a primary backing which includes:
(i) a first nonwoven which comprises fibers comprising polyethylene terephthalate (PET), and
(ii) a second nonwoven which comprises non-melting fibers and is mechanically bonded; and
tufts of yarn which are sewn through the primary backing such that piles of yarn are on a surface of the first nonwoven and backloops of yarn are on a surface of the second nonwoven, wherein the backloops of yarn are thermobonded to the primary backing.

2. The tufted carpet according to claim 1, wherein the yarns are PET yarns.

3. The tufted carpet according to claim 1, wherein the non-melting fibers are from regenerated cellulose, aramide, polyacrylonitrile, partially oxidized polyacrylonitrile, or natural fibers.

4. The tufted carpet according to claim 1, wherein the second nonwoven comprises a mixture of the non-melting fibers and melting fibers, wherein the melting fibers have a melting point of at least 240° C.

5. The tufted carpet according to claim 1, wherein the second nonwoven is spunlaced.

6. The tufted carpet according to claim 1, wherein the first nonwoven is thermobonded.

7. The tufted carpet according to claim 1, wherein
the first nonwoven comprises a mixture of PET fibers and fibers from a lower melting polymer material,
or wherein the first nonwoven comprises multicomponent fibers comprising a PET component and a component from a lower melting polymer material.

8. The tufted carpet according to claim 1, wherein the primary backing consists of the first and second nonwoven.

9. The tufted carpet according to claim 1, further comprising a back coating on the surface of the second nonwoven.

10. A method for preparing the tufted carpet of claim 1, the method comprising:
(a) providing a stack comprising:
(i) the first nonwoven which comprises fibers comprising polyethylene terephthalate, and
(ii) the second nonwoven which comprises non-melting fibers and is mechanically bonded;
(b) sewing tufts of yarn through the stack, such that the piles of yarn are on the surface of the first nonwoven and the backloops of yarn are on the surface of the second nonwoven; and
(c) thermobonding the backloops of yarn.

11. The method according to claim 10, wherein the thermobonding is carried out at a temperature of at least 250° C.

12. A shaped part, which comprises a molded form of the tufted carpet of claim 1.

13. A method for preparing the shaped part of claim 12, the method comprising:
(a) providing the tufted carpet, and
(b) molding the tufted carpet.

14. A primary backing for a tufted carpet, the primary backing comprising:
a first nonwoven which comprises PET fibers; and
a second nonwoven which comprises non-melting fibers and is mechanically bonded.

15. The primary backing of claim 14, wherein the tufted carpet is prepared in a thermobonding process.

16. The tufted carpet according to claim 3, wherein the natural fibers are from cotton, cellulose, wood pulp, bamboo or wool.

17. The tufted carpet according to claim 7, wherein the lower melting polymer material for thermobonding is copolyester.

18. The tufted carpet according to claim 9, further comprising a secondary backing adhered to the back coating.
